(19) United States
(12) Patent Application Publication
(10) Pub. No.: US 2016/0148438 A1
(43) Pub. Date: May 26, 2016

(54) TAPPOINT UNIQUE IDENTIFIER SYSTEM AND METHODS OF USING THE SAME

(71) Applicant: Walid Johnson, Chicago, IL (US)

(72) Inventor: Walid Johnson, Chicago, IL (US)

(21) Appl. No.: 14/550,507

(22) Filed: Nov. 21, 2014

(51) Int. Cl. G07B 15/02; H04B 5/00

(52) U.S. Cl. CPC G07B 15/02; H04B 5/0025

(57) ABSTRACT

A parking management system including a parking management unit having a memory, a processor and a GPS, including an application in the memory that performs the steps of retrieving an identifier from a NFC chip embedded into a sticker on a vehicle, determining the location of the NFC chip via the GPS unit, determining the amount of time the vehicle will park at the location, and initiating a timer showing the amount of time left for the vehicle to park at the location.

### RELATED APPLICATIONS

This application is a non-provisional application that claims the benefit of an the priority from U.S. Provisional Application No. 61/907,000 filed Nov. 21, 2013, titled “Communication Process.”

### BACKGROUND OF THE INVENTION

Storing information on a device or piece of equipment normally requires the use of elaborate optical scanners and other equipment. These devices are susceptible to incorrect scans that can result in errors in the system. A need exists for a system that will allow users to gather information on a device without optical the use of optical scanners.

### SUMMARY OF THE INVENTION

One embodiment of the present invention includes a parking management system including a parking management unit having a memory, a processor and a GPS, including an application in the memory that performs the steps of: retrieving an identifier from a NFC chip embedded into a sticker on a vehicle; determining the location of the NFC chip via the GPS unit; determining the amount of time the vehicle will park at the location; initiating a timer showing the amount of time left for the vehicle to park at the location.

Another embodiment includes the identifier is received by placing a NFC reader in the proximity of the car sticker.

Another embodiment includes the location of the NFC chip is converted to a street address.

Another embodiment includes including the steps of reading the identifier by a second device, determining the time remaining on the timer, issuing a ticket the user associated with the NFC chip if the timer has expired.

In another embodiment, the first material is cotton.

In another embodiment, the first material is paper.

### BRIEF DESCRIPTION OF THE DRAWING

Details of the present invention, including non-limiting benefits and advantages, will become more readily apparent to those of ordinary skill in the relevant art after reviewing the following detailed description and accompanying drawings, wherein:

FIG. 1A depicts a method of manufacturing a TapPoint Unique Identifier (“TUID”) unit;

FIG. 1B depicts a TUID embedded between two pieces of material, such as paper;

FIG. 2 depicts a block diagram of TUID registration system suitable for use with the methods and systems consistent with the present invention;

FIG. 3 depicts a more detailed depiction of the computer;

FIG. 4 shows a more detailed depiction of the computers;

FIG. 5 depicts an schematic representation of the operation of the registration unit;

FIG. 6 depicts a schematic representation of a user paying for parking using the TUID system; and

FIG. 7 depicts a schematic representation of a ticket being issued for parking after the timer has expired.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

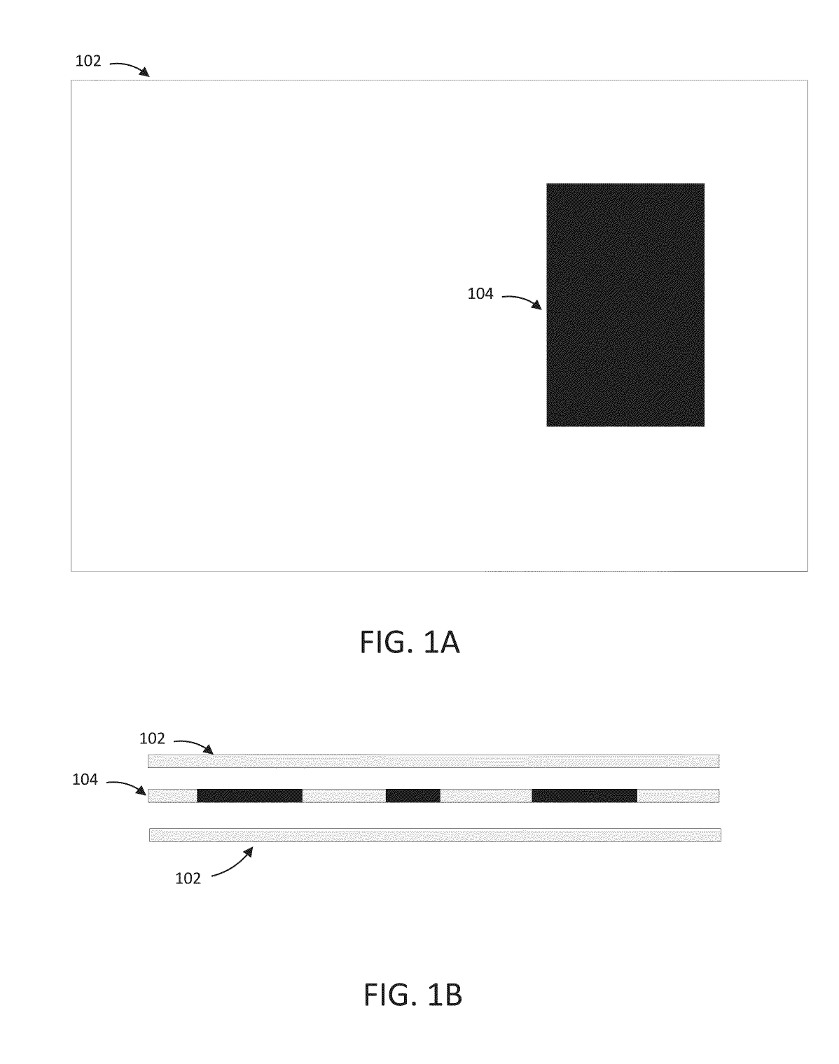

FIG. 1A depicts a method of manufacturing a TapPoint Unique Identifier (“TUID”) unit. The TUID includes a paper sheets 102 with a near field communication (“NFC”) chip 104 placed between the two sheets of paper 102 such that one sheet of paper is one surface of the NFC chip 104 and the other sheet of paper 102 is on the opposite side of the NFC chip 104. In one embodiment, the substrate of the TUID chip is paper. In one embodiment, the paper 102 is 11 inches wide by 17 inches long and the NFC chip is positioned adjacent to one side edge of the paper. In another embodiment, the paper 102 is 279.4 cm wide by 432.8 cm long. The two sheets of paper 102 are bonded via an adhesive such that the NFC chip 104 is secured between the two pieces of paper 102. After sealing the NFC chip 104 is encoded with a unique identification number using any known method of encoding an NFC chip. In one embodiment, the NFC chip 104 is encoded with a bit strength of 196 bits and 4 additional bit patterns used to route information to specific destinations. In one embodiment, the first bit of the 4 additional bits represents a company product version, the second bit represents the version of the product, the third bit represents the region of the assumed designation of the product and the fourth bit represents the subscription level of the product. In another embodiment, the 4 additional bits include a series of subbits. The subbits may include user information including name, address and phone, e-commerce tokens for purchasing, identification and authorization codes for the user's social network accounts, a location of the user and the position of the user in relation to a reader.

After the sheets of paper 102 are sealed and the NFC chip 104 is encoded, the pages are cut to a desired size using any known cutting methods. In one embodiment, the sheets are cut to a predetermined with of approximately 5.5 inches based on a width of 11 inches such that the sheets can slide though a 4 sheet 2 staple fold. After cutting, the sheets are double sided printed in four colors.

FIG. 1B depicts a TUID embedded between two pieces of material, such as paper 102. The material may also be a fabric including, but not limited to, cotton or a cotton covered fusion material. Consistent with this embodiment, a TUID chip having a cotton substrate, is placed between two pieces of cotton 102. The cotton covered fusion material 102 is headed to a temperature of 150 degrees F. using a heating press and the TUID chip having a cotton substrate is sealed between the cotton layers 102.

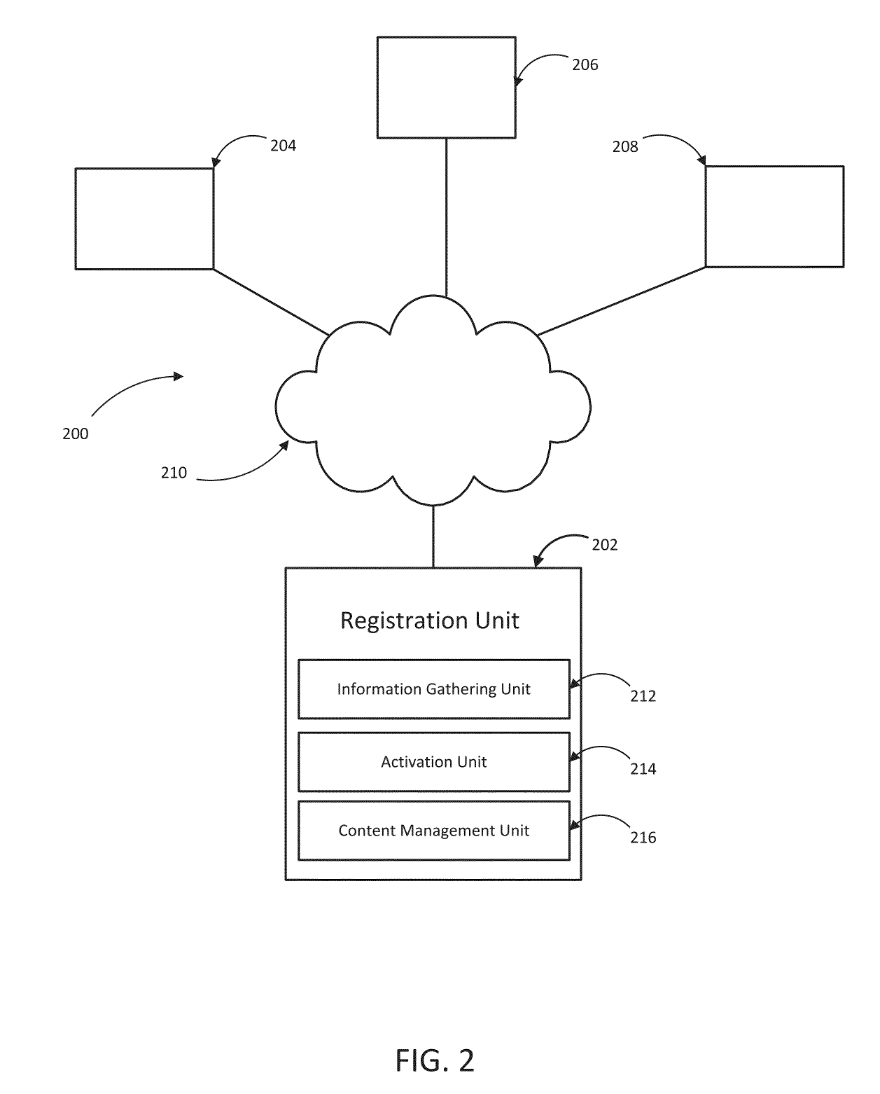

FIG. 2 depicts a block diagram of TUID registration system suitable for use with the methods and systems consistent with the present invention. The registration system 200 comprises a plurality of computers 202, 204, 206 and 208 connected via a network 110. The network 108 is of a type that is suitable for connecting the computers for communication, such as a circuit-switched network or a packet switched network. Also, the network 210 may include a number of different networks, such as a local area network, a wide area network such as the Internet, telephone networks including telephone networks with dedicated communication links, connection-less network, and wireless networks. In the illustrative example shown in FIG. 1, the network 210 is the Internet. Each of the computers 202, 204, 206 and 208 shown in FIG. 1 is connected to the network 210 via a suitable communication link, such as a dedicated communication line or a wireless communication link.

In an illustrative example, computer 202 serves as a registration unit that includes an information gathering unit 212, a goal analysis unit 214, a goal retrieval unit 216, a goal modification unit 218, and a goal maintenance unit 220. The number of computers and the network configuration shown in FIG. 1 are merely an illustrative example. One having skill in the art will appreciate that the goal tracking system 200 may include a different number of computers and networks. For example, computer 202 may include the information gathering unit 212 as well as one or more of the goal analysis unit 214 and goal maintenance unit 220. Further, the goal retrieval unit 216 and goal modification unit 216 may reside on a different computer than computer 202.

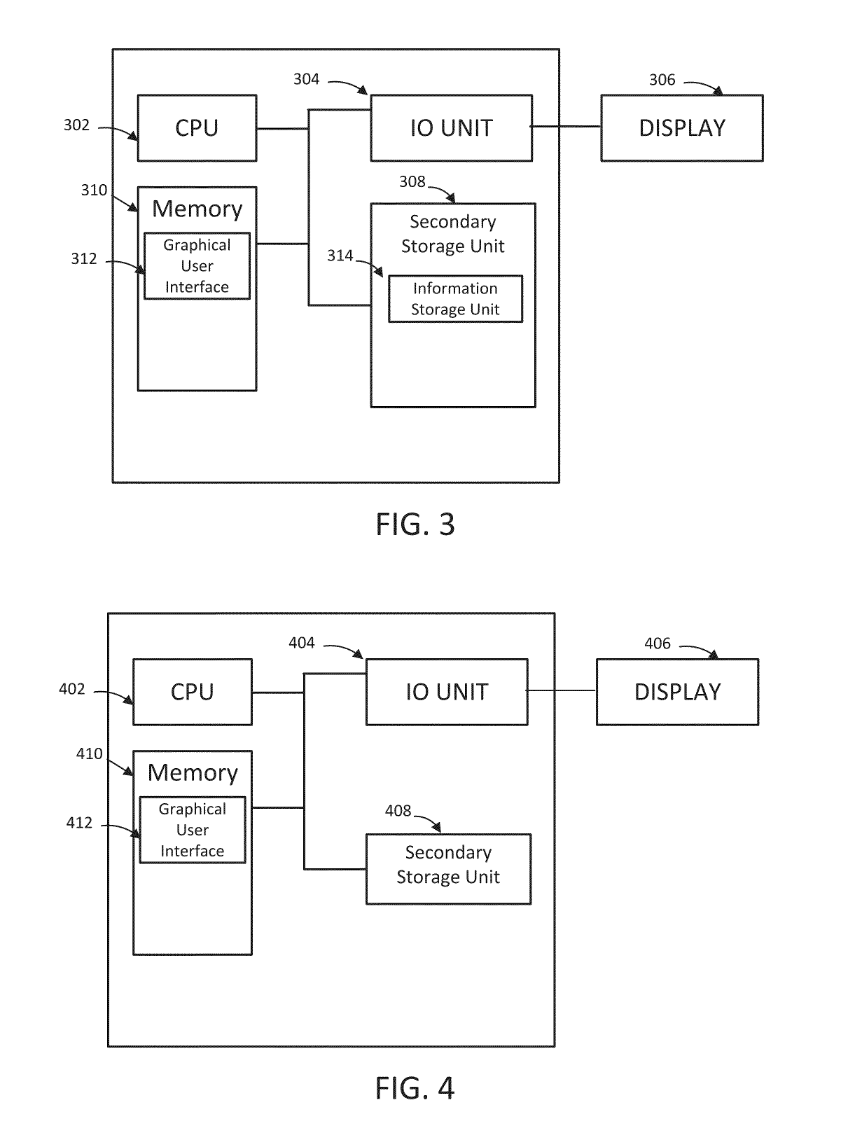

FIG. 3 depicts a more detailed depiction of the computer 302. The computer 302 comprises a central processing unit (CPU) 202, an input output (IO) unit 304, a display device 306 communicatively coupled to the IO Unit 304, a secondary storage device 308, and a memory 310. The computer 302 may further comprise standard input devices such as a keyboard, a mouse, a digitizer, or a speech processing means (each not illustrated).

The computer 202's memory 310 includes a Graphical User Interface (“GUI”) 312 which is used to gather information from a user via the display device 306 and I/O unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available hypertext markup language (“HTML”) viewing software such as, but not limited to, Microsoft Internet Explorer, Google Chrome or any other commercially available HTML viewing software. The secondary storage unit 308 may include an information storage unit 314. The information storage unit may be a rational database such as, but not including Microsoft's SQL, Oracle or any other database.

FIG. 4 shows a more detailed depiction of the computers 204, 206 and 208. Each computer 204, 206 and 208 comprises a central processing unit (CPU) 402, an input output (I/O) unit 404, a display device 406 communicatively coupled to the IO Unit 404, a secondary storage device 408, and a memory 410. Each computer 204, 206 and 208 may further comprise standard input devices such as a keyboard, a mouse, a digitizer, or a speech processing means (each not illustrated).

Each computer 204, 206 and 208's memory 410 includes a GUI 412 which is used to gather information from a user via the display device 406 and I/O unit 404 as described herein. The GUI 412 includes any user interface capable of being displayed on a display device 406 including, but not limited to, a web page, a display panel in an executable program, or any other interface capable of being displayed on a computer screen. The GUI 412 may also be stored in the secondary storage unit 208. In one embodiment consistent with the present invention, the GUI 412 is displayed using commercially available hypertext markup language (“HTML”) viewing software such as, but not limited to, Microsoft Internet Explorer, Google Chrome or any other commercially available HTML viewing software.

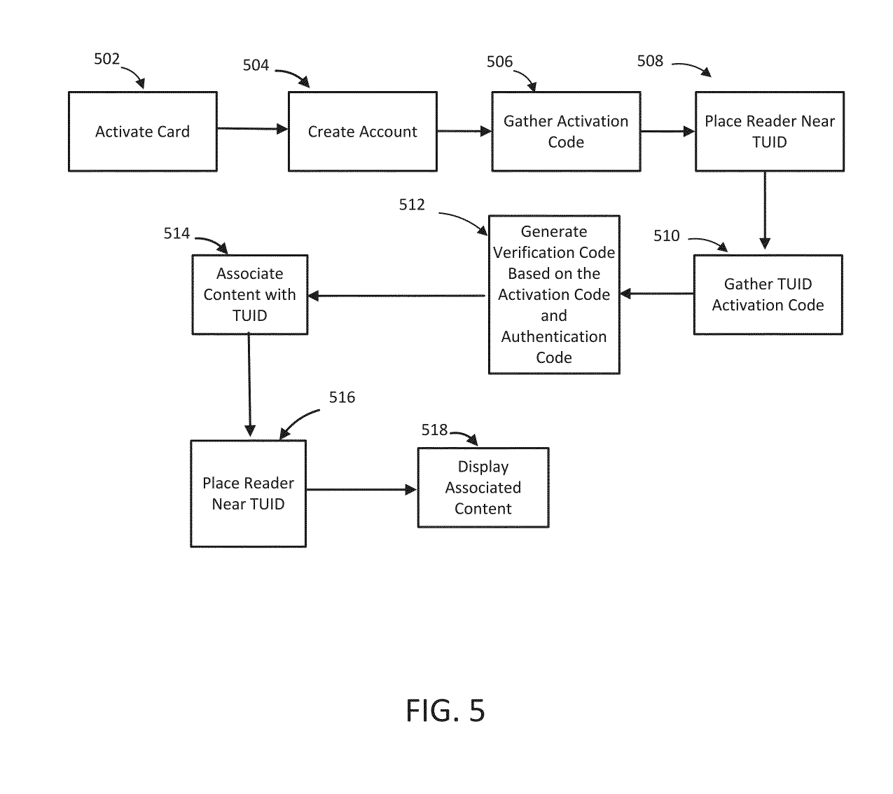

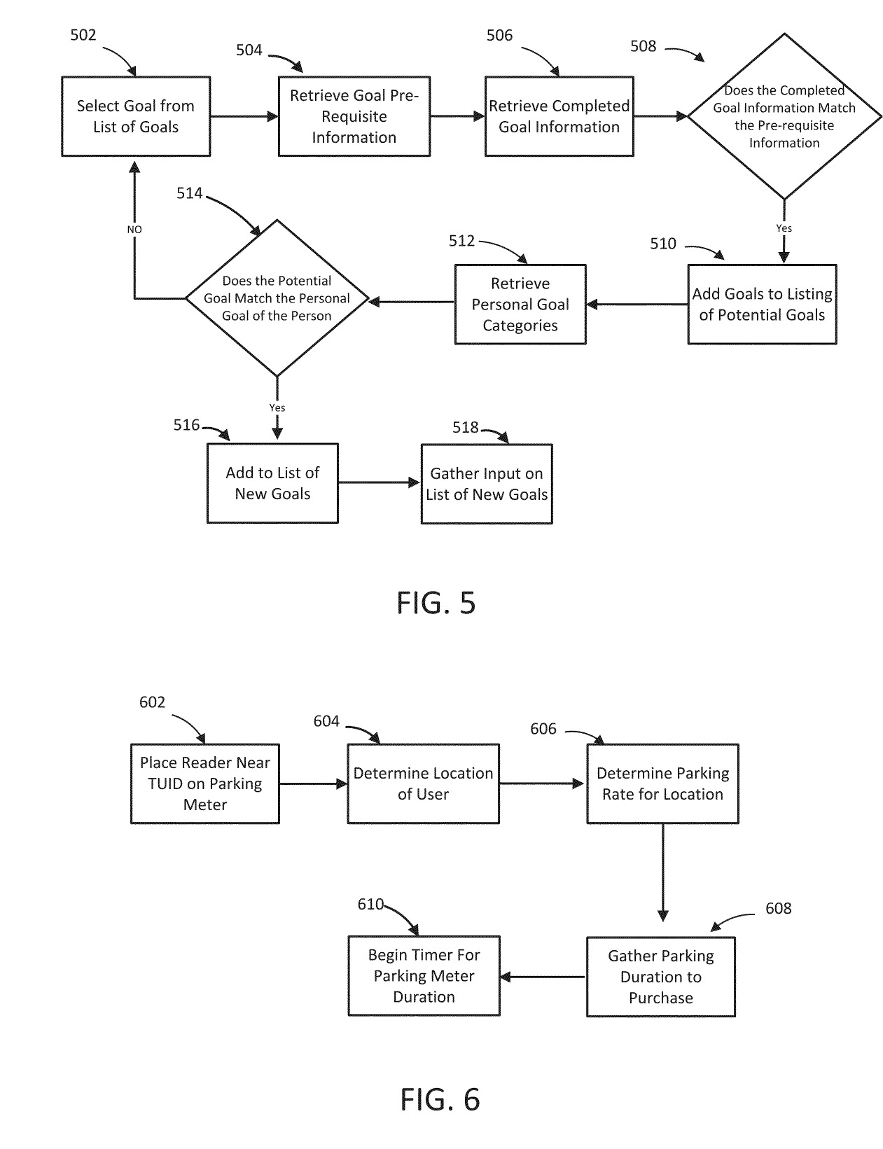

FIG. 5 depicts an schematic representation of the operation of the registration unit. In step 502, the TUID is activated by granting access to a user to a web site for activation. In step 504, the user establishes an account. The account may include information on the user including, but not limited to, the age, gender, address of the user along with the TUID identifier. In step 506, the activation cod for the TUID is gathered via the information gathering unit 212. The activation code may be entered into the system by the user. In step 508, a reader device communicatively coupled to the I/O Unit 304 of the registration unit 200 is placed in the general proximity of the TUID. The activation unit 214 display a request for the user to enter the authentication code on the TUID tag or the material surrounding the TUID tag. As an illustrative example, the authentication code may be printed on a tee-shirt having a TUID embedded in the fabric of the tee-shirt. In step 512, the activation unit 214 generates a verification code based on the authentication code and the activation code. In another embodiment, the verification code is based on the authentication code only. In another embodiment, the verification code is based on the activation code only.

In step 514, the activation unit 214 associates the TUID with the user account and content associated with the user account. Content may include, but is not limited to audio or video files, links to web sites, links to online deal offers, documents, images or any other content. In step 518, the reader is placed in the general proximity of the TUID and the TUID gathers the TUID identification from the TUID. In step 518, the content management unit 216 gathers the content associated with the TUID and displays the content to the user or another user.

FIG. 6 depicts a schematic representation of a user paying for parking using the TUID system. In one embodiment, the TUID is affixed to a vehicle. In step 602, a reader is placed in the general proximity of a TUID affixed to a the vehicle that is associated with a user account. In step 604, a Global Positioning System unit communicatively coupled to the I/O unit 304 of the registration unit 202 determines the location of the registration unit 202 when the reader reads the TUID. In step 606, a predetermined parking rate is determined based on the location of the user when the reader is placed in the proximity of the TUID. In step 608, the user agrees to purchase a predetermined period of time at the retrieved rate. In step 610, upon acceptance of the rate and time, a timer that is associated with the user account and vehicle sticker counts down the remaining time for vehicle to park at the location.

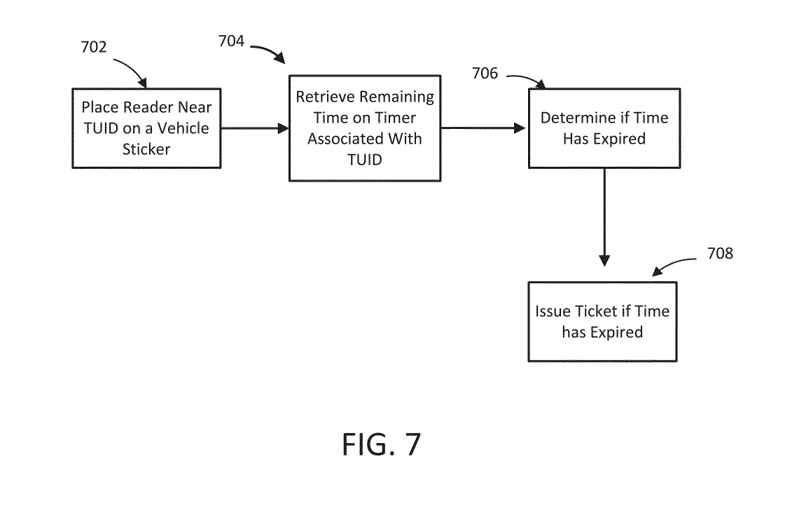

FIG. 7 depicts a schematic representation of a ticket being issued for parking after the timer has expired. In step 702, a user places a reader in the proximity of a sticker on a vehicle having an embedded TUID. The reader reads the TUID identifier and stores the TUID identifier in memory. In step 704, the remaining time left of the timer for the timer associated with TUID identifier is retrieved. In step 706, the content management unit 216 determines if any time is left on the timer. In step 708, if no time is left on the timer, the content management unit 216 issues a ticket to the user associated with the TUID identifier.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A parking management system including a parking management unit having a memory, a processor and a GPS, including an application in the memory that performs the steps of:
retrieving an identifier from a NFC chip embedded into a sticker on a vehicle;
determining the location of the NFC chip via the GPS unit;
determining the amount of time the vehicle will park at the location;
initiating a timer showing the amount of time left for the vehicle to park at the location.

2. The method of claim 1 wherein the identifier is received by placing a NFC reader in the proximity of the car sticker.

3. The method of claim 1 wherein the location of the NFC chip is converted to a street address.

4. The method of claim 1 including the steps of
reading the identifier by a second device;
determining the time remaining on the timer;
issuing a ticket the user associated with the NFC chip if the timer has expired.

5. An embedded NFC unit including
a first layer made of a first material;
a NFC chip having a substrate that is the same material as the first layer;
a second layer made of the first material,
wherein the first layer is adhered to the second layer using an adhesive such that the NFC chip is secured between the two layers.

6. The NFC unit of claim 5 wherein the first material is cotton.

7. The NFC unit of claim 5 wherein the first material is paper.
